(19) United States
(12) Patent Application Publication
(10) Pub. No.: US 2025/0265618 A1
(43) Pub. Date: Aug. 21, 2025

(54) System and Method for Facilitating Alternative Branding in Financial Systems

(71) Applicant: ShiftCents, Inc., Woodburn, OR (US)

(72) Inventors: Robert Thacher, Keizer, OR (US); David Hiroshi Hijirida, Honolulu, HI (US); Philip Andrew Oliver, Atlanta, GA (US); Brian Robert Sunter, Honolulu, HI (US); Jira Jessica Vinyoopongphan, Alexandria, VA (US); Piotr Zmudzinski, Gliwice (PL)

(21) Appl. No.: 18/654,269

(22) Filed: May 3, 2024

Related U.S. Application Data
(60) Provisional application No. 63/553,679, filed on Feb. 15, 2024.

(51) Int. Cl. G06Q 30/0251; G06Q 30/0201

(52) U.S. Cl. CPC G06Q 30/0269; G06Q 30/0201

(57) ABSTRACT

Embodiments of a system and method enable secure connectivity between the computer systems of a financial institution and software for Brand On Banking. Embodiments of the system include an Identity Platform, Know Your Customer (KYC) processes including ID card verification, face verification, document verification such as utility bills as proof of address, and biometric verification, and bank servicing features such as checking, savings, debit, payments, loans, and bill-pay. The secure connectivity is established in various embodiments through private or public Application Programming Interfaces (APIs) over a network service provider, thus eliminating third-party risk for the financial institution. Additionally, the system allows for displaying alternate brands and identifying customers associated with a specific product brand other than the financial institution. The mobile interface is user-friendly and consolidates all financial accounts in one location, reducing customer friction.

### CROSS-REFERENCE TO RELATED APPLICATION

The present application claims priority from U.S. Provisional No. 63/553,679 filed Feb. 15, 2024, the disclosure of which is incorporated herein by reference in its entirety.

### TECHNICAL FIELD

The present disclosure relates to financial transaction systems and more particularly to a system and method for facilitating alternative branding in financial systems.

### BACKGROUND AND SUMMARY

In the banking and financial services industry, establishing a competitive advantage relies heavily on brand recognition and customer loyalty. Technical systems are needed for electronically managing alternative branding securely within financial service provider systems. Embodiments of the present disclosure provide a computer system and method that enables the display of an alternative brand on an electronic device when the electronic device is used to access a financial service provider's computing system. Embodiments of the present disclosure enhance brand recognition and customer experience within the banking sector while resolving electronic challenges of current systems. Furthermore, embodiments of the present disclosure create a cohesive and immersive brand experience for financial institution customers.

### BRIEF DESCRIPTION OF THE DRAWINGS

FIG. 1 is a schematic diagram illustrating aspects of a system according to embodiments of the present disclosure.

FIG. 2 is an architectural diagram illustrating aspects of a system according to embodiments of the present disclosure.

FIGS. 3 and 4 are example flow diagrams of processes in accordance with the present disclosure.

### DESCRIPTION OF EMBODIMENTS

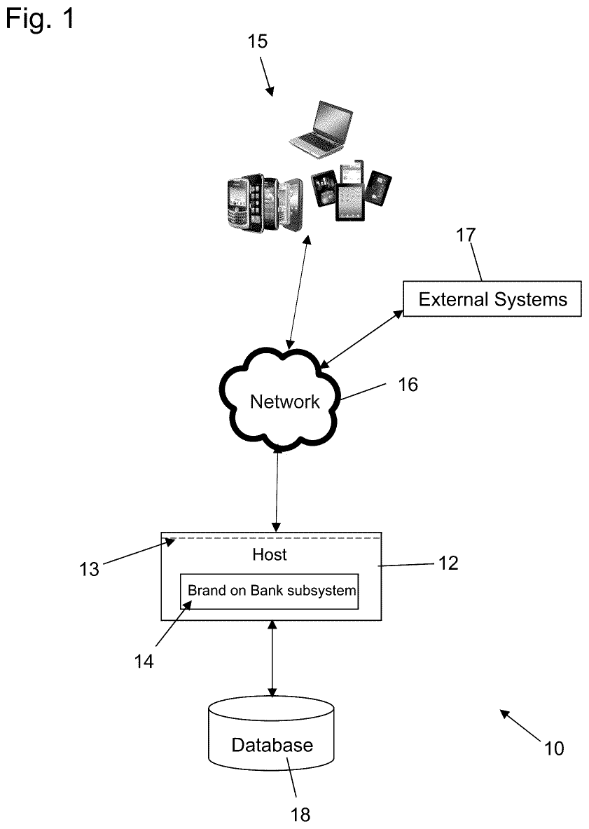

In various embodiments such as shown in FIG. 1, a system 10 according to the present disclosure includes a host 12 such as a financial institution computing system adapted to operate a Brand On Banking subsystem 14, where the Brand On Banking subsystem 14 is stored and operates behind the host's firewall 13. The host 12 is in communication with a database 18 and the host 12 provides user interfaces that are accessible by various types of user electronic devices 15, which can include smartphones, cellular phones, laptops, desktops, tablets, notebooks and other forms of electronic communication and/or computing devices. The devices 15 access the host 12 via network 16, and one or more external systems 17 can be provided in communication with the host 12 and/or devices 15 via network 16.

Brand On Banking refers to a financial institution offering its services under the brand name of another company for revenue relevance to streamline branding management capabilities for financial institutions and their businesses. Brand On Banking enables a range of financial services to be offered that includes deposit accounts, credit cards, loans, investment products, and insurance products. In various embodiments, the Brand On Banking subsystem 14 can be provided as a white-labeled platform that utilizes financial technology to assist businesses in establishing their brand on top of a bank, enabling access to multiple streams of new revenue, for brand sustainability.

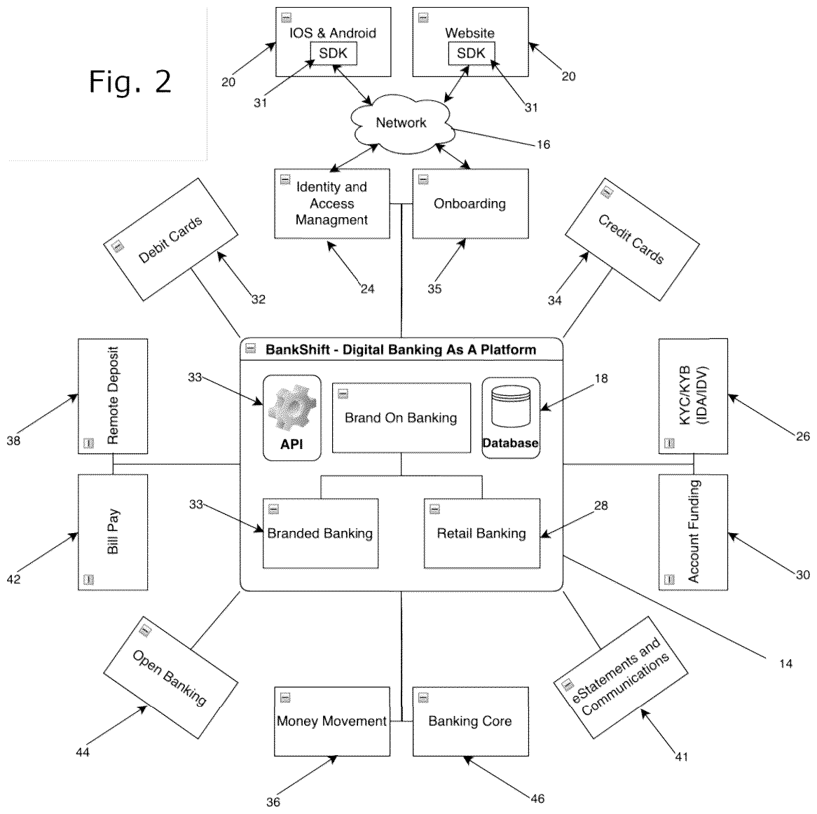

As shown in FIG. 2, the Brand On Banking subsystem 14 according to the present disclosure can include one or more software development kits 31 and one or more application programming interfaces (APIs) 33 that assist in establishing a framework for integrating brand elements into various banking services, including account management, transactions, and customer support. The Brand On Banking subsystem provides software programming enabling features such as branded user interfaces such as may be provided on an interface of a mobile device 20 and/or accessed via a website 22, customized messaging, and visual cues that align with a financial institution client's brand identity. The Brand On Banking subsystem 14 can be accessed via network 16 according to embodiments of the disclosure.

Embodiments of the subsystem 14 according to the present disclosure enable secure connectivity between the computer system(s) of a financial institution (e.g., host 12 in FIG. 1) and software for Brand On Banking. As further shown in FIG. 2, embodiments of the subsystem 14 include a branded banking component 27, a retail banking component 28 (e.g., for checking accounts, savings accounts, etc.), one or more APIs 33 and one or more SDKs 31. The external banking system host 12 can include components such as an Identity and Access Management Platform 24, Know Your Customer (KYC) 26 processes including ID card verification, face verification, document verification such as utility bills as proof of address, and biometric verification, and bank servicing features such as account funding 30, debit card 32, credit card 34, customer onboarding 35, money transfers 36, remote deposit 38, payments, loans, e-statements and communications 41 and bill-pay 42. The secure connectivity between subsystem 14 and host 12 can be established in various embodiments through private or public APIs 33 over a network service provider, thus eliminating third-party risk for the financial institution. Additionally, the branded banking component 27 allows for displaying alternate brands and identifying customers associated with a specific product brand other than the financial institution. The mobile interface is user-friendly and can consolidate financial accounts and digital currency wallets in one location, reducing user financial anxiety.

As further shown in FIG. 2, open banking 44 provides third-party access to financial data such as through the use of the application programming interfaces (APIs) 33. Also, core banking 46 is available in embodiments of the present disclosure as a back-end system that processes banking transactions across the various branches of a bank.

It will be appreciated that the system for secure connectivity between a software platform and a financial institution's computer systems can thus include private or public APIs (e.g., 33), alternative branding such as via branded banking component 27, logging into an identity and access management platform such as component 24, KYC/KYB/OFAC/AML processes such as shown at 26 and bank servicing features such as checking, savings, debit, credit, payments, loans, remote deposit capture and bill-pay as shown in FIG. 2.

Secure connections can be provided by establishing a connection through private or public APIs over a network service provider. Displaying alternate brands and identifying customers associated with a specific product brand other than the financial institution can be provided via branded banking component 27. Component 24 assists with performing login processes, including signup, login or forgot username and password. Component 26 assists with processes for onboarding, including ID card verification, face verification and document verification, for example. Accessing bank servicing features such as checking, savings, credit cards, debit cards, payments, loans, remote deposit capture and bill-pay is provided through components such as shown in FIG. 2 which are accessible via host 12.

In various embodiments, personalized account management is accommodated through the present disclosure by incorporating branding elements into mobile device applications. This includes customized account dashboards, branded transaction history displays, and personalized notifications that reinforce the financial institution client's brand identity which delivers a consistent brand experience to their customers.

Brand-focused transaction processing techniques enhance customer engagement during financial transactions according to the present disclosure. This involves branded transaction confirmations, visually appealing receipts, and personalized transactional messages that leave a lasting impression on customers.

To provide a seamless brand experience, embodiments of the present disclosure also incorporate branding into customer support interactions. This includes utilizing branded communication templates, personalized support interactions, and visual cues that align with the financial institution client's brand identity. These enhancements aim to strengthen customer loyalty and increase brand recognition.

The brand integration system according to the present disclosure utilizes advanced data analysis techniques to optimize branding strategies. By analyzing customer behavior, preferences, and feedback, the system can refine branding elements to maximize their impact and ensure a consistent and compelling brand experience across different touchpoints.

By integrating client brand elements throughout various banking services, embodiments of the present disclosure strengthen brand recognition among customers, differentiate the financial institution from competitors and ensure a consistent and immersive brand experience for customers across different banking touchpoints, reinforcing brand loyalty and customer satisfaction. The personalized features of the present disclosure, such as customized interfaces and messaging, create a more engaging and tailored experience for customers, fostering stronger connections with the brand. Further, financial institutions can employ embodiments of the present disclosure to leverage data analysis to optimize branding strategies, allowing financial institutions to refine their approaches based on customer insights and preferences.

By offering a unique and alternative branded banking experience, embodiments of the present disclosure help financial institutions such as banks gain a competitive edge in the market and attract new customers.

In specific embodiments, a computer system and method according to the present disclosure facilitates the display of an alternative brand on electronic devices by way of banking as a platform (BaaP), software development kits, financial institutions, their clients, and their customers' electronic devices.

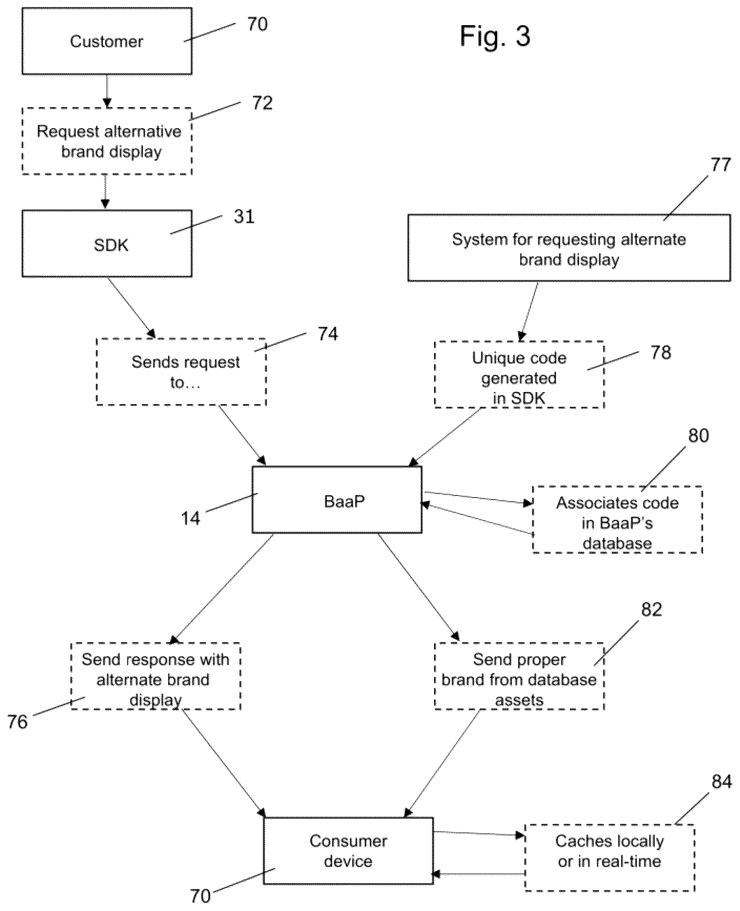

In various embodiments such as illustrated in FIG. 3, for example, a system for requesting alternate brand display on a financial institution customer's consumer electronic device operates using banking as a platform (BaaP) and software development kits, wherein a financial institution's customer's consumer electronic device 70 requests an alternate brand display as at 72 via a software development kit (SDK) 31, and this request is sent by the SDK 31 as at 74 and received by the BaaP 14 (e.g., subsystem 14), which then sends the response with the alternate brand display as at 76 to the electronic device 70. When a user updates or downloads the financial institution's mobile app or a financial institution's business partner's mobile app from a website or app store, the app can operate as the system for requesting alternate brand display 77 and a unique code can be generated in the software development kit as at 78, wherein the code gets associated in the BaaP's database as at 80. The BaaP (e.g., subsystem 14) can then send, as at 82, the proper brand from the BaaP's database assets to the financial institution's customer's consumer electronic device 70, which can cache it locally or in real-time, for example, as at 84.

In various embodiments, the financial institution's customer's consumer electronic device sends an API request to the BaaP, which then forwards the request to the financial institution's computer system (e.g., host 12), and the financial institution's computer systems respond with an API connection.

In various embodiments, the BaaP sends an identity request to the financial institution's identity platform, the identity platform verifies the identity and responds with an identity response to the BaaP and forwards the identity response to the financial institution's computer system (i.e. host 12).

In various embodiments wherein the BaaP requests a KYC process from the KYC platform, the KYC platform responds with a KYC process response to the BaaP and forwards the KYC process response to the financial institution's computer system.

In various embodiments wherein the BaaP sends a bank servicing request to the servicing platform, the servicing platform responds with a bank servicing response to the BaaP, and the BaaP forwards the bank servicing response to the financial institution's computer system.

In various embodiments wherein the BaaP sends an identity processes request (in response to the API identity request), a KYC processes request, and a bank servicing request to the financial institution's computer system, the financial institution's computer system responds with an API interface response, a KYC processes response, and a bank servicing response to the BaaP.

### Use Case 1

A large grocery chain seeks to expand their existing loyalty program. The grocery chain may desire to offer financial technology services with its brand in accordance with the present disclosure so loyal shoppers can get, e.g., a certain amount of food for free as an introductory offer and/or get a percentage discount on food in the various stores.

### Use Case 2

A coffee company seeks to connect with people in the most meaningful way. The coffee company may desire to offer financial technology services with its brand in accordance with the present disclosure so loyal fans can get rewards and/or obtain a certain amount of coffee for free.

### Use Case 3

An automotive company seeks to expand its existing loyalty program. The company may desire to offer financial technology services with its brand in accordance with the present disclosure so loyal car fans can pay for services or their next down payment at a discount or for free, for example.

It will be appreciated that embodiments of the system and method as described in accordance with the present disclosure provide a technical solution to the challenge of conveying alternative brands securely within a financial institution's banking system. The system can be provided as a computer-based system, where the components can be implemented in hardware, software, firmware, or combinations thereof, as illustrated in FIGS. 1 and/or 2, for example. It will be appreciated that access can be provided over a public or private network 16, including the Internet, in various embodiments of the present invention. Further, external systems 17 (see FIG. 1) can be accessed via the present system for temporary storage of files or other functions consistent with the present disclosure. Embodiments of the system and method can process large volumes of communications and instructions in near real-time while integrating alternative branding as appropriate.

In various embodiments, the present disclosure provides a computer-implemented system for facilitating alternative branding in financial systems. The system can include a database module configured to store alternative branding data associated with one or more commercial offerings, a user interface module configured to receive input for initiating alternative branding preferences, a processing module and a communication module. The processing module can be a SDK operable to receive a request for a financial transaction, retrieve alternative branding data from the database module and apply the alternative branding data to one or more of the commercial offerings. The communication module is configured to transmit the alternative branded commercial offering to a user.

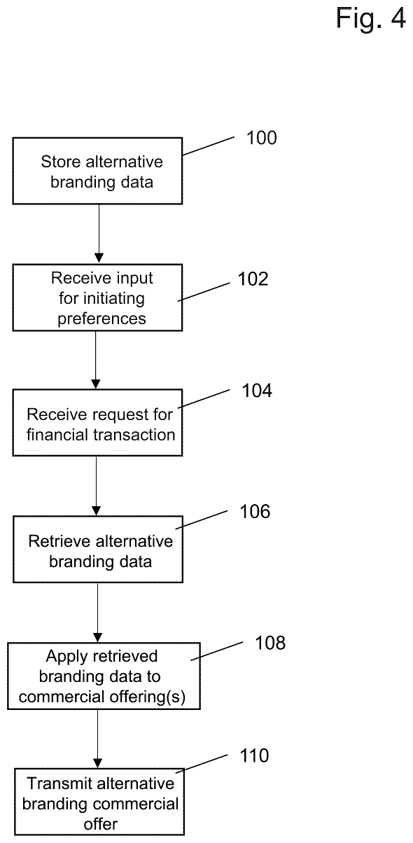

According to various embodiments, a method is disclosed herein for facilitating alternative branding in financial systems. As shown in FIG. 4, as at step 100, alternative branding data associated with various commercial offerings is stored. As at step 102, input for initiating alternative branding preferences is received. At step 104, a request for a financial transaction is received. As at step 106, alternative branding data from the stored alternative branding data is retrieved. As at step 108, the retrieved alternative branding data is applied to one or more of the commercial offerings, and as at step 110, the alternative branded commercial offering is transmitted to a user.

It will be appreciated that embodiments of the system and method described herein can operate such that the input is received from the user or from the processing module. Further, the commercial offerings can be based on a preference of the user or based on the processing module and can further be a type of financial product or service. Examples of alternative branding data include one or more of a customized logo, a color scheme and a promotional message associated with the commercial offering. In various embodiments, the processing module is also operable to execute a machine learning algorithm configured to analyze behavior and preferences of the user.

It will further be appreciated that a banking mobile SDK can be incorporated with the system and can be configured to embed one or more banking functionalities in the system. The banking mobile SDK facilitates access to various banking services within a branded user interface. In various embodiments, the banking services are account management, external accounts, transactions, and customer support services.

It will further be appreciated that embodiments of the user interface module include a tokenization mechanism configured to pass a token into the banking mobile SDK, facilitating the association of branding elements stored in the database module. According to various embodiments, the tokenization mechanism enables the dynamic retrieval and application of branding elements, including logos, color schemes, and promotional messages, from the database module to customize the user interface of the banking experience based on user preferences.

The above-described embodiments of the present disclosure may be implemented in accordance with or in conjunction with one or more of a variety of different types of systems, such as, but not limited to, those described below.

The present disclosure contemplates a variety of different systems each having one or more of a plurality of different features, attributes, or characteristics. A “system” as used herein refers to various configurations of: (a) one or more hosts; and optionally (b) one or more other computing devices, such as one or more servers, computing platforms, desktop computers, laptop computers, tablet computers, personal digital assistants, mobile phones, and other mobile computing devices.

The host(s) and/or other computing devices can be any suitable computing device (such as a server) that includes at least one processor and at least one memory device or data storage device. As further described herein, the processor can be configured to transmit and receive data or signals representing events, messages, commands, or any other suitable information.

In embodiments in which the system includes a computing device configured to communicate with a host through a data network, the data network can be a local area network (LAN), a wide area network (WAN), a public network such as the Internet, or a private network. The host and the computing device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium.

It will be appreciated that any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing, including a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented as entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

It will be appreciated that all of the disclosed methods and procedures herein can be implemented using one or more computer programs or components. These components may be provided as a series of computer instructions on any conventional computer-readable medium, including RAM, SATA DOM, or other storage media. The instructions may be configured to be executed by one or more processors which, when executing the series of computer instructions, performs or facilitates the performance of all or part of the disclosed methods and procedures.

Unless otherwise stated, devices or components of the present disclosure that are in communication with each other do not need to be in continuous communication with each other. Further, devices or components in communication with other devices or components can communicate directly or indirectly through one or more intermediate devices, components or other intermediaries. Further, descriptions of embodiments of the present disclosure herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed computers and computing devices, for example. In this regard, a processor (e.g., a microprocessor or controller device) receives instructions from a memory or like storage device that contains and/or stores the instructions, and the processor executes those instructions, thereby performing a process defined by those instructions. The instructions can be those from banking SDK, for example, in accordance with various embodiments of the present disclosure. Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object-oriented programming language, a conventional procedural programming language, a dynamic programming language, a hybrid language or another programming language. Exemplary programming languages that may be employed include, for example, Java, Javascript, Typescript, Scala, Smalltalk, Eiffel, JADE, Emerald, C++, C#, VB.NET, Python, Visual Basic, Fortran 2003, Perl, COBOL 2002, PHP, ABAP, Kotlin, Swift, Python, Ruby and Groovy. The program code may execute entirely on a user's computer, partly on a user's computer, as a stand-alone software package, partly on a user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment.

Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art. Appropriate encryption and other security methodologies can also be employed by the system of the present disclosure, as will be understood to one of ordinary skill in the art.

The present disclosure describes numerous embodiments of the present invention, and these embodiments are presented for illustrative purposes only. These embodiments are described in sufficient detail to enable those skilled in the art to practice the invention embodiments, and it will be appreciated that other embodiments may be employed and that structural, logical, software, electrical and other changes may be made without departing from the scope or spirit of the present invention. Accordingly, those skilled in the art will recognize that the present invention may be practiced with various modifications and alterations. Although particular features of the present invention can be described with reference to one or more particular embodiments or figures that form a part of the present disclosure, and in which are shown, by way of illustration, specific embodiments of the invention, it will be appreciated that such features are not limited to usage in the one or more particular embodiments or figures with reference to which they are described. The present disclosure is thus neither a literal description of all embodiments of the invention nor a listing of features of the invention that must be present in all embodiments.

1. A computer-implemented system for facilitating alternative branding in financial systems, comprising:
a database module configured to store alternative branding data associated with a plurality of commercial offerings;
a user interface module configured to receive input for initiating alternative branding preferences;
a processing module, comprising a processor and a memory storing instructions that, when executed by the processor, cause the processor to:
receive a request for a financial transaction;
retrieve alternative branding data from the database module; and
apply the alternative branding data to a commercial offering from the plurality of commercial offerings; and
a communication module configured to transmit the alternative branded commercial offering to a user.

2. The system of claim 1, wherein the input is received from the user.

3. The system of claim 1, wherein the input is received from the processing module.

4. The system of claim 1, wherein the plurality of commercial offerings is based on a preference of the user.

5. The system of claim 1, wherein the plurality of commercial offerings is based on the processing module.

6. The system of claim 1, wherein the alternative branding data comprises at least one of: a customized logo, a color scheme and a promotional message associated with the commercial offering.

7. The system of claim 1, wherein the plurality of commercial offerings comprises financial products or services.

8. The system of claim 1, wherein the instructions further cause the processor to execute a machine learning algorithm configured to analyze behavior and preferences of the user.

9. The system of claim 8, wherein the machine learning algorithm is further configured to dynamically adjust the alternative branding applied to the commercial offering.

10. A method for facilitating alternative branding in financial systems, comprising:
storing alternative branding data associated with a plurality of commercial offerings;
receiving input for initiating alternative branding preferences;
receiving a request for a financial transaction;
retrieving alternative branding data from the stored alternative branding data;
applying the retrieved alternative branding data to a commercial offering from the plurality of commercial offerings; and
transmitting the alternative branded commercial offering to a user.

10. (canceled)

11. The method of claim 10, wherein the input is received from the processing module.

12. The method of claim 10, wherein the plurality of commercial offerings is based on a preference of the user.

13. The method of claim 10, wherein the plurality of commercial offerings is based on the processing module.

14. The method of claim 10, wherein the alternative branding data comprises at least one of: a customized logo, a color scheme and a promotional message associated with the commercial offering.

15. The method of claim 10, wherein the plurality of commercial offerings comprises financial products or services.

16. The method of claim 10, wherein the instructions further cause the processor to execute a machine learning algorithm configured to analyze behavior and preferences of the user.

17. The method of claim 16, wherein the machine learning algorithm is further configured to dynamically adjust the alternative branding applied to the commercial offering.

18. The system of claim 1, further comprising:
a banking mobile SDK configured to embed one or more banking functionalities in the system.

19. The system of claim 18, wherein the banking mobile SDK facilitates access to a plurality of banking services within a branded user interface, wherein the plurality of banking services comprises two or more of: account management, external accounts, transactions, and customer support.

20. The system of claim 18, wherein the user interface module further comprises:
a tokenization mechanism configured to pass a token into the banking mobile SDK, facilitating the association of branding elements stored in the database module.

21. The system of claim 20 wherein the tokenization mechanism enables the dynamic retrieval and application of branding elements, including logos, color schemes, and promotional messages, from the database module to customize the user interface of the banking experience based on user preferences.

22. The method of claim 10, wherein the input is received from the user.
